(19) United States
(12) Patent Application Publication
(10) Pub. No.: US 2025/0171694 A1
(43) Pub. Date: May 29, 2025

(54) Method and Device for Pyrolysis-Based Production of Hydrocarbon Oils Based on Plastic Containing Raw Material

(71) Applicant: INRIGO AS, Heimdal (NO)

(72) Inventors: Rajesh Shivanahalli Kempegowda, Trondheim (NO); Uladzimir Kalitko, Minsk (BY)

(21) Appl. No.: 18/725,615

(22) PCT Filed: Dec. 21, 2022
(86) PCT No.: PCT/NO2022/050325

§ 371 Date: Jun. 28, 2024

(30) Foreign Application Priority Data
Dec. 31, 2021 (NO) 20211602

(51) Int. Cl. C10B 53/07; B01J 6/00; C10B 47/44; C10B 53/02; C10B 57/00; C10B 57/06; C10G 1/02

(52) U.S. Cl. CPC C10B 53/07; B01J 6/008; C10B 47/44; C10B 53/02; C10B 57/005; C10B 57/06; C10G 1/02; C10G 2300/1003

(57) ABSTRACT

A method and reactor assembly for pyrolysis-based production of hydrocarbon oils from a first plastic raw material, comprising
optionally combining the plastic raw material with a second raw material selected from the group consisting of a hydrocarbon containing raw material selected among crumb rubber and wood chunks in an amount constituting more than 15% by weight of the combined raw material
adding a catalyst to the combined raw materials to thereby form a reaction composition,
charging the reaction composition through an airlock valve to an auger pyrolysis reactor comprising at least two auger reactors heated to a temperature in the range 450-550° C.,
diverting oil vapours and non-condensable vapours from the auger reactors to a condensing device,
condensing in two steps a heavy oil fraction and a light oil fraction from said vapours.

### BACKGROUND

The disclosed embodiments relate to a method for pyrolysis based production of hydrocarbon oils and to an associated device.

Use of plastic materials for conversion into energy rich products in the form of fuel oils is a major focus in the broader perspective of recycling and use of plastic materials.

The plastic materials may be incinerated as such, but this process typically generate toxic dioxins.

Pyrolysis is a more promising candidate for an environmentally friendly use of the plastic waste for conversion into energy. In pyrolysis the raw material is heated in the absence of oxygen and the material is thereby converted to liquid oil products with a high energy content which is better suited for fuel than the plastic material as such.

A vast number of patent publications (patents as well as applications) exists in this technical field, hereunder U.S. Pat. Nos. 5,608,136; 5,811,606; 6,866,830; 13,126,811; 5,856,599; 5,129,995; 8,344,195; 9,212,318; 9,725,655; 10,093,860 and others; US 2009/0062581; US 2009/0321317; US 2011/0259726; US 2015/0001061; US 2017/0073584 and others; PCT Publications WO 2005/071043; WO 2007/069449; WO 2008/022790; WO 2010/049824; WO 2014/167141, WO 2018/000050, and others which relate to many different methods and types of pyrolysis apparatus such as batch and rotary batch, fixed and fluidized bed, kilns and rotary kilns, as well as single, double and multi-auger reactors.

WO 2008/022790 and US 2009/0321317 relate to method and device for multi-auger pyrolysis processing of plastic-containing and organic fluids based on crude oil, cooking oil, fats or the like. The reaction mixture is fed into a reactor, melted in a melting zone of the reactor and the interfering substances are discharged from the melt. Long-chained polymers still present in the melt are then cracked in a crack zone of the reactor until they assume a gaseous state. These patents disclose a shaftless (helical) screw as well capable type of that for auger and multi-auger pyrolysis processing an adhesive substance of such waste when plastic content melting. Due to the plastic melt flooding occurring inside the reactor and excess relative to non-melt portions. There are no solutions of limiting of such conditions along with the steady auger processing along the length of the reactor. Due to this auger and multi-auger pyrolysis system has until now not been able to process plastic material efficiently due to its melting and flooding.

In this regard many patented solutions in the field of plastic pyrolysis such as U.S. Pat. Nos. 5,811,606; 6,866,830; 13,126,811; WO 2010/049824, WO 2018/000050 are based simply on melting and batch processing provided with stirring such of batch pyrolysis reactor. A general problem with these methods is deposition of coke at the reactor bottom causing a reduced heat transfer and a need for frequent cleaning of the reactor, involving undesired interruption of production.

The plastics waste processing in a traditional pyrolysis process have several problems due to melting of plastics starting in the temperature range of 150 to 200° C. depending on the characteristics of the plastics while the required pyrolysis temperature is in the range of 450-500° C.

Different catalysts have been used for waste plastic pyrolysis as for decreasing the temperature, as for upgrading the oil fuel content to less wax content and so on, doing that with dolomite catalyst in U.S. Pat. No. 8,344,195, ZSM-zeolite and FCC-catalyst in U.S. Pat. No. 9,212,318. However, there is a typical problem with catalysts degradation because of its inner micro-porous surface area contamination with pyrolysis coke, by which reason it must be renewed or regenerated, or at least partially removed and mixed with a fresh catalyst. The dolomite catalyst discussed in U.S. Pat. No. 8,344,195, is proposed just to be frequently removed and replaced by fresh catalyst prepared from a cheap fossil of natural dolomite matter by oxidation and calcination at the temperature 900-1000° C. So, it can be recognized that there is no effective solution for catalyst continuous regeneration in this field along with pyrolysis processing.

Catalysts have been used in pyrolysis processes, but problems are encountered also in connection with the use of catalysts. In auger-based reactors, there are problems due to the creation of such melt conditions. Furthermore, both batch and continuous pyrolysis reactors experience carbonaceous coke layer formation during heating and thermal cracking of the liquid melt plastic. This condition will deactivate the catalyst used in the pyrolysis process and reduce the heat transfer rate. Consequently, it will lead to the formation of a coke layer, usually inside the reactor surfaces and on the auger shaft, if an auger-containing reactor is used.

### SUMMARY

Provided herein is a method and a device for improved pyrolysis of plastic material in which the above mentioned disadvantages are reduced or eliminated.

As disclosed herein, helical multi-auger reactors have been found useful in a pyrolysis process of plastic containing material. The plastic material is combined with a different material having properties that serve to make the reaction composition more viscous, ensuring that the reaction composition does not form a low-viscous fluid mass under the reaction conditions in the reactor. At the same time, the combination of the reaction composition (combined raw material) does not plug the reactor or form carbonaceous coke layer on the reactor walls or the auger parts. Such coke layer deposits would reduce the heat transfer and restrict the thermal transfer between the reactor walls and material inside the reactor and is therefore highly undesirable.

In embodiments, a first raw material component in the form of plastic is subjected to a treatment in combination with a second component, which may be either one of a particularly selected (first) catalyst and a second raw material component selected among rubber and wood.

The reactor material SS304-321 safety specification is corresponded maximally to around 800° C. temperature classification at which it is well possible to use and regenerate Al₂O₃ catalyst, doing that at 650° C. as required in literature, as well as a typical catalyst ZSM-5 that is regenerated at 500-550° C. in the same manner.

In an embodiment in which no first catalyst is present, the second raw material component should not be less than 30% by weight if constituted solely by rubber. If the second raw material component is constituted solely by wood particles, it should be present in an amount not less than 15% by weight. Such combinations of raw materials ensure that the viscosity of the mass is maintained at a level when conveyed through the reactor providing a tight seal between the auger and the reactor wall and that build-up of char or other deposits on the reactor wall is prevented.

The same effect may be achieved by combining the plastic raw material with an effective amount of a catalyst exhibiting viscosity controlling properties. Such catalyst may for instanced be one or more of metal oxides, such as e.g. alumina. The amount of catalyst to be included may be adapted to the particular raw material, since plastic material may have various physical properties in dependence of the kind of plastics encountered.

Further according to the present method and device, catalyst regeneration is inherent in the process and therefore does not require a pause in the operation thereof. The regeneration temperature of the catalyst takes place at a temperature of about 650° C., which is about 150-200° C. higher than the temperature in the reaction zone of the pyrolysis process. The most adequate catalysts for the process are zeolite catalysts, Al₂O₃ and/or dolomite based catalysts.

Another inherent feature of the disclosed embodiments is the heating which is provided at least in part by burning of the gases generated by the process. In this sense the present device and method does not require external heating or can be combined with electric or other heating only when commercial aspects are in favour of such external heating.

At the reaction temperature, the product oils are vaporized and the vapour needs to be cooled to form liquid oil. The product vapour is preferably cooled in two steps to generate to different oil fractions, a heavy oil fraction and a light oil fraction.

### BRIEF DESCRIPTION OF THE DRAWINGS

Below, the invention is described in further details in the form of non-limiting embodiments with reference to the drawings, where

FIG. 1 is a schematic, simplified flow scheme illustrating the basic elements of the disclosed device and method;

FIG. 2 is a schematic set-up of a complete plant incorporating the basic elements of the disclosed embodiments;

FIG. 3 is a sectional side view of some core elements of the disclosed device;

FIG. 4 is an exploded side sectional view similar of the components of FIG. 3;

FIG. 5 is a side sectional view of other elements of the disclosed device:

FIG. 6 is a detailed view of condenser elements of the disclosed device;

FIG. 7 illustrates operation of the condenser elements shown in FIG. 6.

### DETAILED DESCRIPTION

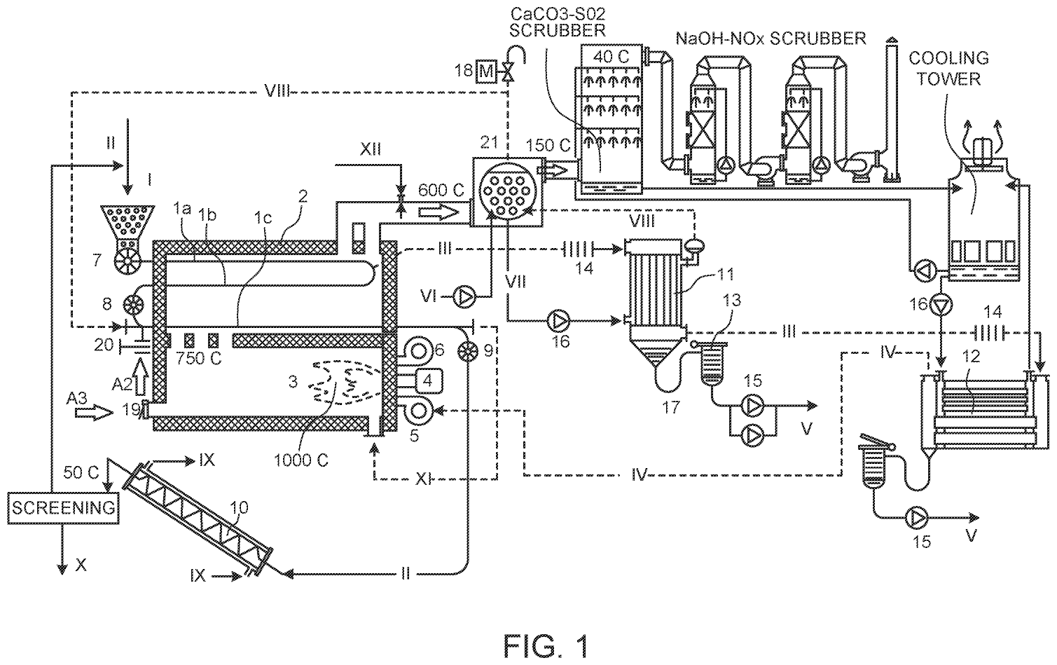

FIG. 1 shows a heat box 2 or retort enclosing a first 1a and second 1b auger reactor, serially connected and a third 1c tubular reactor serially connected to the second 1b auger reactor. An airlock valve 7 is shown at the inlet of the first auger reactor and another airlock valve 8 at the outlet of the second auger reactor 1b. In the lower region of the heat box 2 a heating device 3 in the form of a gas flame furnace, typically comprising a burner 4 is arranged to heat the different reactors to desired temperatures. Insulating materials may be present in the heat box, and/or the heat box may have inherent temperature insulating properties. The heating device 3 may suitably include a burner 4 making use of non-condensable gases generated by the process as fuel.

From a position at the outlet of the first and second auger reactor 1a, a flow (III) of material in the form of hot oil vapour is shown, directing the hot oil vapour to a first cooling unit in the form of an oil condenser 11 where heavy parts of the hot vapour (heavy oil boiling range) is converted to a heavy oil fraction. This will take place at a temperature of about 100° C. The remaining vapour is passed on to a second condenser 12, in which the temperature is reduced further, converting condensable vapour to a lighter oil fraction V. The first condenser 11 is preferably cooled using hot, or even boiling water. The second condenser 12 is typically cooled with warm water at a temperature in the range 60-75° C.

The flows shown In FIG. 1 is I: raw material comprising a major part of plastic material, II: catalyst recycle flow; III: oil vapour from auger reactor; IV: non-condensable gas (hydrogen containing) used for heating; V: pyrolysis oil as a main product; VI: fresh water; VII: boiling water for cooling/condensing the hot vapour; VIII: steam generated when cooling hot oil vapour and typically used further in the char treatment/catalyst regeneration; IX: cooling water for cooling and condensing the lighter vapour fractions; X: ash rest and waste water; XI: exhaust flue gas.

Preferably, the first as well as the second auger reactor is of a shaftless kind, which means that the auger at the outlet end may rotate with a different rate than the auger near the inlet end of the reactor(s), which serves the function of ensuring a more steady filling of the auger reactor from inlet to outlet with dependence of volume variations caused by the pyrolysis process progressing throughout the length of the auger by optimization of residence time.

In operation, the raw material and a catalyst is charged through the airlock valve 7 into the first auger reactor 1a which is heated to a temperature in the range 450-500° C. To initiate the pyrolysis process, a start-up fuel oil is used as a start fuel to achieve the pyrolysis temperature. Later, the process uses self-generated pyrolysis off-gases for continuous heating of the process to achieve the process temperature as specified above. The auger is operated to move the material through the first reactor at a velocity chosen in order to achieve a suitable retention period with regard to the desired pyrolysis to take place.

When a second raw material is combined with the plastic material, the catalyst is typically selected from the group consisting of dolomite, zeolite, natural or industrial granulated catalyst matters of the heterogeneous type that can refine and maximize the pyrolysis oil production even operating at a lower pyrolysis temperature.

When plastic material is used as the sole raw material, the catalyst chosen is typically Al₂O₃ but may also be CaCO₃, MgCO₃, flyash or the like, alone or in combinations.

Catalyst is preferably selected among zeolitic catalysts and in the case that a second raw material is combined with the first raw material.

The catalytic pyrolysis is prone to catalyst deactivation caused by impurity of carbonaceous coke deposition at the inner micro-porous surface area of catalyst. The catalyst normally must be changed or thermally regenerated. As known by research and publishing in [5-7] the catalyst regeneration of zeolite catalysts ZSM-5, HZSM-5, HUSY among others, can be performed by burning out the coke impurity. Regeneration happens by low-speed oxidation with air at temperature under 550° C. to avoid irreversible loss of catalyst acidity and so-called catalyst calcination temperature. Calcination can be avoided by regular stirring and supply of cooling steam agent.

Tubular reactors 1a, 1b, 1c are arranged such a way that maximum thermal efficiency reached based on the hot gases flow in the heat box in a crossflow indirect movement of hot-gases and which flow upward with different temperature regimes as shown FIG. 1.

In the first auger the plastic material is heated and start melting in the range of 180 to 250° C. whereas the crumby rubber, when used as the second component of the feed material, usually decompose above 350° C. This means the rubber materials acts as a filling and aids in steady screwing, maintaining a certain viscosity to the feed as a whole.

The viscous fluid mixture along with catalyst flows to the second auger reactor 1b with lowered rotary speeds for the cross-section flow of reactor to be steadily near to full during the processing length. In the second auger reactor, the pyrolysis material mass is destructed and evaporated, while the reactor residence time is significantly enhanced. The unconverted pyrolyzed carbon is taken out from rotary lock valve to a third tubular reactor having properties as described below.

In the third tubular reactor 1c, which typically is of a kind of regenerative type tubular reactor housed with shaft based peddle agitator, in this the remaining material is heated to a higher temperature than in the auger reactors, with purpose of catalyst continuous regeneration by stirring and thermal oxidizing with air and steam supply. The third tubular reactor is arranged with paddle shafted design and hermetically separated from other parts, by which way both pyrolysis and self-regenerative catalyst are maintained at a common heating temperature typically in the range of 500-550° C. A cooling steam agent is typically added to avoid any catalyst calcination. In this step carbon monoxide and hydrogen are generated.

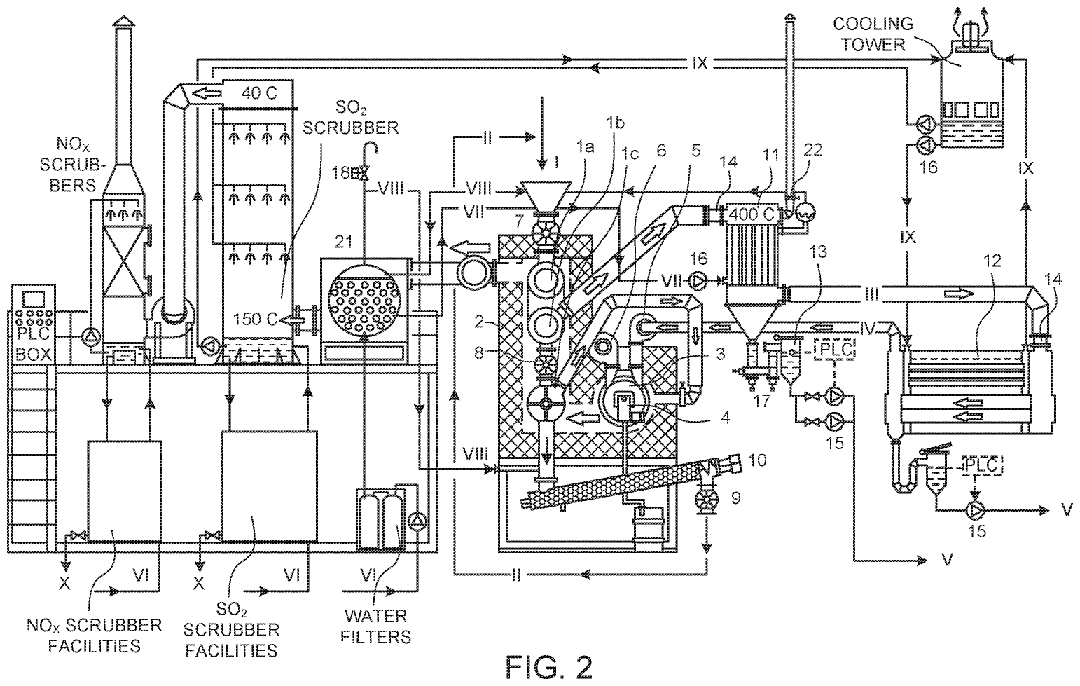

FIG. 2 is an overview of a reactor setup based on the principles shown In FIG. 1, including further elements that typically are present in a real-life embodiment, such as NOx scrubbers and SO2 scrubbers and water filters. The main concept of the process is the same as in FIG. 1. The flows indicated with Roman numbers are as described above with reference to FIG. 1.

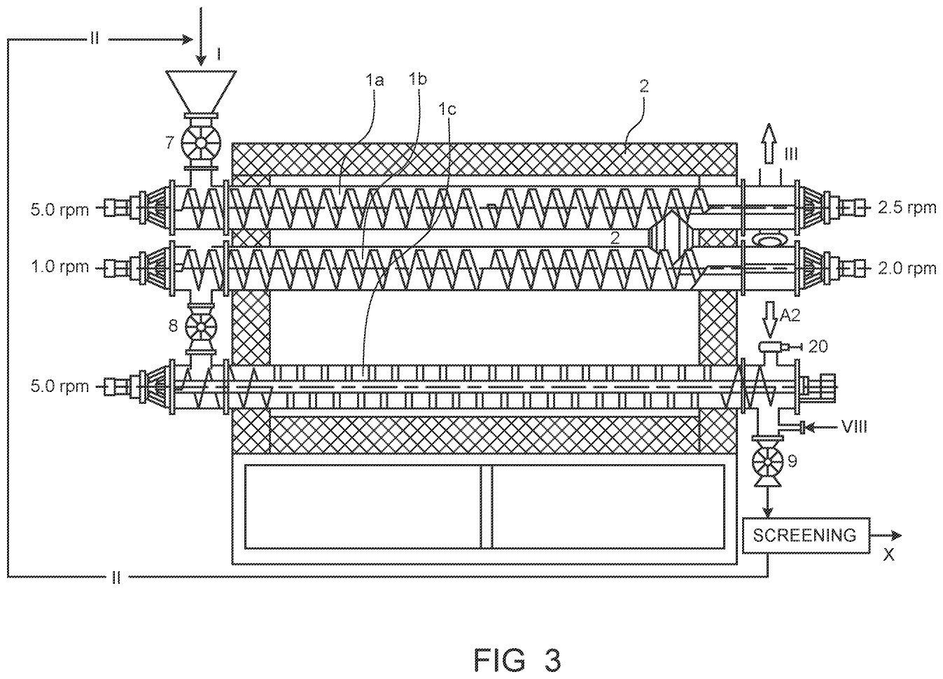

FIG. 3 is a side sectional view of the heat box 2 housing the two auger reactors in which the pyrolysis takes place and the third tubular reactor in which the catalyst is regenerated. As seen in the two auger reactors, the augers are divided in an inlet half and an outlet half, allowing different rotational speed at the outlet end from the speed at the inlet end.

Typical arrangement of crushing, granulating, and feeding units that are usually applied for waste plastics will be preliminarily prepared for co-pyrolysis of blended mixtures processing. This also includes a rotary airlock valve as preferably proposed for felling and feeding of blended mixture bulk material consisting of rubber mixture of 5-6 mm size as maximum. At the same time, in case of woody biomass/chips a double-flap airlock valve is typically used for such of filling of 20-25 mm. This is mainly due to the characteristics of wood hardness and chip size which are prone to jamming in rotary airlocks valves.

As for embodiment of the present system detail, a shell tube body of a double auger shaftless pyrolysis reactor is proposed to be typically made of boiler steel 1020 or 1040 (thickness 6-10 mm which is dependent on diameter), allowing a shaftless helical screw inside can also be made of the same steel and thickness due to process occurs in the absence of oxygen.

In contrast to that, a shell tube body of the catalyst retort, including the multi-paddle screw inside, must be specially made of stainless steel SS304 or SS321 due to the conditions of thermal oxidation with air supply for catalyst regeneration inside at around 550-550° C. and possibly at 650° C. maximum.

AC-motors of gear cycloid and flange-maintained type are typically used for rotation of both screw's pyrolysis reactor and catalyst retort augers. Both will be specially equipped with a frequency inverter (HZ-driver) for achieving different rotary speeds. The speed ranges from 1.0 rpm minimum to 7.5 rpm maximum. The corresponding operational power capacity in the range from 1.5 kW to 5.5 kW (in dependence on auger diameter). Auger speeds can be controlled by both manual and PLC-control for automatic process to control the feedstock specific product control. Reactor start-up is performed by industrial dual fuel burner 4 that is auto-burner for preheating pyrolysis reactor to achieve pyrolysis temperature of 45° C. This is performed within the time duration of 1.5 hours.

Automatic tuning of flame control of fuel burner 4 is adjusted for its flame temperature in the furnace 3 to be in the preheating range of 550 to 850° C. provided by its automatic middle-maximum operating mode to achieve the reactor operating temperature and correspondingly steam over-pressure in the steam boiler 21 to be not less than about 0.5 bar at the same time when the boiler is typically and automatically supplied with water.

The steam drain to outside is typically as shown in FIGS. 1-3 when the motor control valve 20 for steam supply into the catalyst retort 2 is closed automatically or manually. Along with such of preheating, being provided with boiler 21 operating already, the oil condenser 11 is preliminarily and fully filled with boiling water. A draft fan is operated first, providing an under-pressure in furnace typically not less than −0.05 kPa. At these thermal and other conditions, the present system is ready for loading and operating as considered below.

Added steam through the motor controlled valve 20 has the function of controlling the temperature in the tubular reactor 1c in which the regeneration of catalyst occurs.

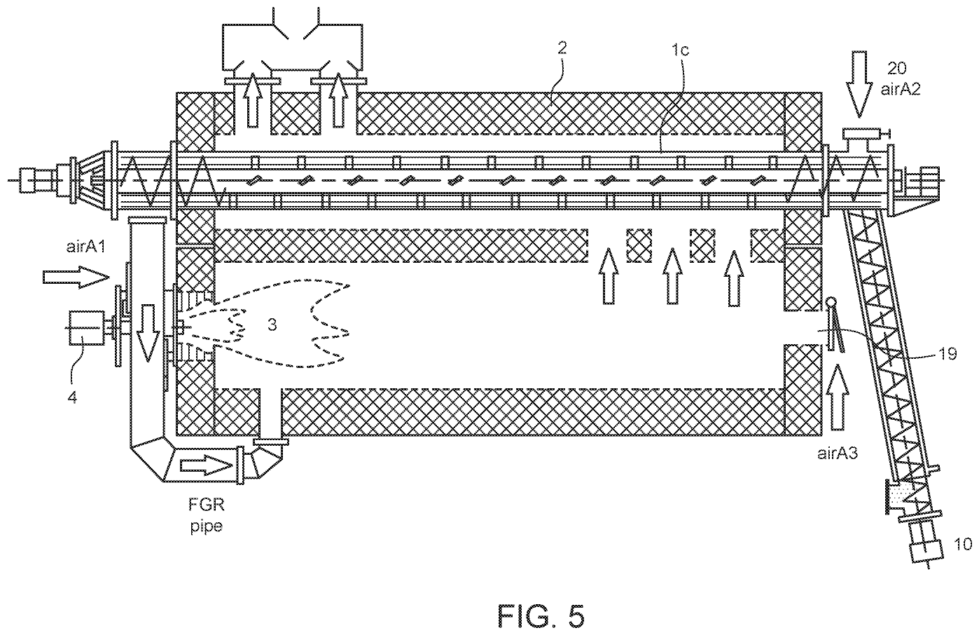

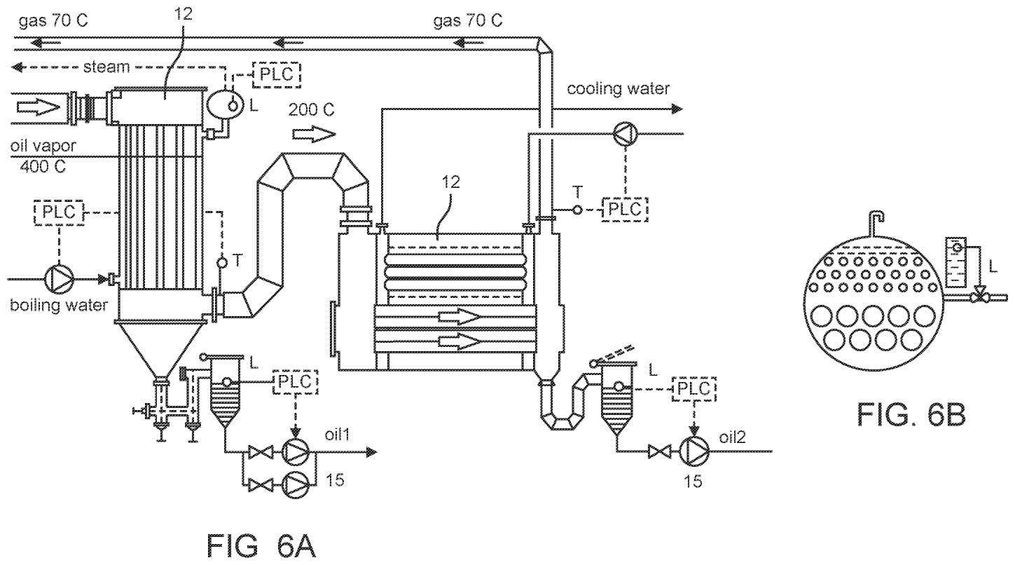

The system has an automatic control system but has also it is possible to operate it manually. FIGS. 5-6 illustrate the typical PLC-control configuration for the gas flame temperature control with combusting air A1 in the furnace 3 provided by means of the air blower 6; the outlet temperature control in the catalyst retort with a steam cooling agent supplied into that by means of a motor control valve 20, and both of the oil condensing temperatures outlet control in the oil condensers 11-12 are provided by means of the boiling and cooling water screw pumps 16. It can also be simplified and performed by manual control procedure as preferably for lab-scale or pilot plant of the present system. At the same time, the control level performance of steam boiler 21 and both of oil piping pumps are provided automatically as required by a standard regulation of such units.

In connection to that above, the present system for industrial oil burner and its startup preheating is also typically of automatic control mode. In particularly of triple-step operating mode like a small, middle, and big flame as considered in the present system as described below.

The burner heat capacity is typically not less than that of the residual gas burning rate in the amount of 15-20% wt. of mixed plastic heat value after pyrolysis oil condensation to achieve the amount of 80-85% of that correspondingly. The burner is operated and controlled in a triple-step mode like a small, middle, and big flame as considered in detail for the present system description are provided below. In terms of the heat capacity, it is approximately corresponded to the ratio as follows:
0.35 MW for preheating the present system per 0.25 ton/hr,
0.5 MW for preheating the present system per 0.5 ton/hr,
0.75 MW for preheating the present system per 1.0 ton/hr.

In the present system as shown fragmentally in FIG. 3 along with preheating of the reactor and all the augers of the pyrolysis reactor 1a, b, c and heat box 2, as well as rotary or double-flap airlock valves 8-9 and discharge auger 10 are arranged to be switched on operating mode. Order of procedure sequence beginning from the last to first unit feeding rotary airlock valve 8 must be switched on for operating in the last order before operating any of typical conveyor or hopper loading system. At the end, sequence when the latter is started for loading the reactor, at the same time sequence of switching on the gas fan 5 and as for pyrolysis oil vapour exited from the process to be sent via piping from reactor to the oil condensers 11-12 and return piping arrangement for recycling of non-condensable residual gas from the condenser into gas furnace 3 are typically arranged as simultaneous sequencing technique. This also solves the requirement of under-pressure condition in pyrolysis reactor around −50 Pa as required usually by a single fan arrangement.

Estimated around 0.5 hr. after loading to the present system when combustible residual synthetic gas is available for piping into the furnace 3 as noticed above where it is injected through the multi-orifice nozzles as shown in FIG. 5. The recycled gas is ignited with preheating oil flame burner 4 as it is still under operation with preheating temperature at 800-850° C. As a result of injection of recycled synthetic gas furnace, temperature will shoot around 1000° C. within the span of 5-10 minutes. To adjust the flame temperature in the burner to be automatically turned for its minimal operating with a small flame mode setting, this will be achieved by its triple step-by-step mode, and while the air blower 6 is operated automatically to start the operation to dilute the gases with combusting air A1 as required for stabilizing the gas flame temperature not above 1000° C. In proposition in case of emergency, manual control is preferred, it is allowed for the same operation to be performed at the same time with air blower controlled manually. An allowance is provided for the temperature raise to around 1100° C.

As the pyrolysis reactor operating temperature is around 500° C. and heat required for pyrolysis process provided by indirect sweeping of hot flue gas around furnace at 700-750° C., the latter is achieved by sweeping temperature as proposed to be adjusted by one more diluting air injection point A2. This is achieved by manually and simply through an open hole equipped with a flip-flap dumper arrangement 19 as shown in FIGS. 1 and 3.

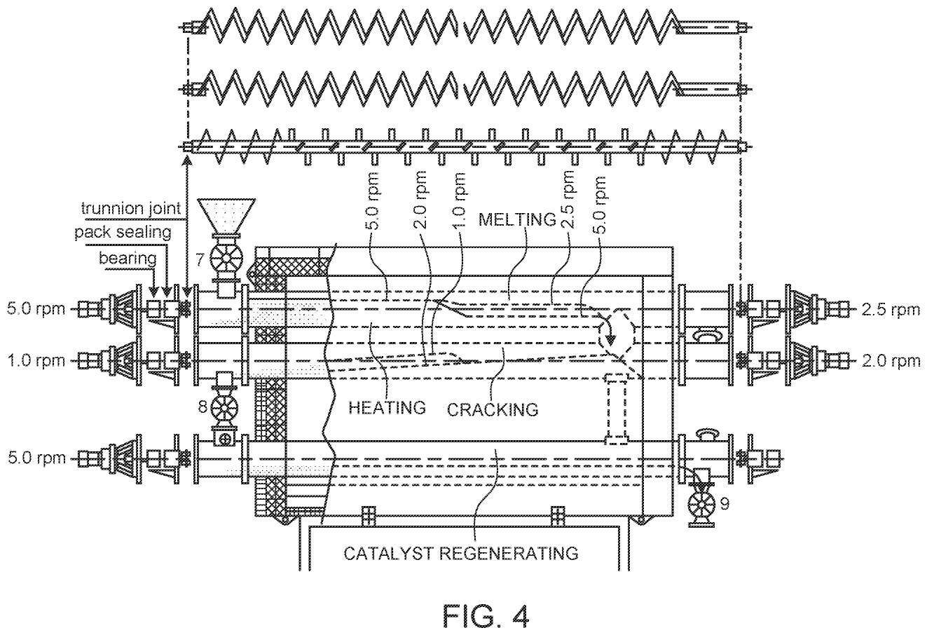

At these thermal conditions both furnace 3 and reactor 1 are proposed for steady continuous operations for subjecting mixed plastics catalytic pyrolysis with its new innovated configuration performance as considered below. FIG. 4 illustrates the transformation of mixed plastics bulk volume with pyrolysis process by heating, melting and thermal cracking along with its steady screwing in pyrolysis reactor. Bulk plastics subjected for melting in the reactor will reduce the bulk volume by 2-2.5 times with crumb rubber or wood chips. It is estimated that in case of plastic flake processing, expected a reduction of 6-7.5 times (per 1 kg mixture), proposing all the plastic melt is included in a porous volume of these bulk matters' medium (excludes catalyst):
plastic flakes bulk density=100 kg/m³
plastic granules bulk density=500 kg/m³
Crumb rubber bulk density=350 kg/m³
crumb rubber bulk porosity=68%
wood chips bulk density=150 kg/m³
wood chips bulk porosity=80%

Version1: plastic granules with crumb rubber (65/35% by weight):
Mixture feeding volume=0.65/500+0.35/350=2.3 litres
Mixture melt volume=crumb rubber bulk medium=0.35/350=1 litre

Version2: plastic granules with wood chips (80/20% by weight):
Mixture feeding volume=0.8/500+0.2/150=2.95 litres
Mixture melt volume=wood chips bulk medium=0.2/150=1.35 litre

Version3: plastic flakes with crumb rubber (65/35% by weight):
Mixture feeding volume=0.65/100+0.35/350=7.5 litres
Mixture melt volume=crumb rubber bulk medium=0.35/350=1 litre

Version4: plastic flakes with wood chips (80/20% by weight):
Mixture feeding volume=0.8/100+0.2/150=9.35 litres
Mixture melt volume=wood chips bulk medium=0.2/150=1.35 litre

In this regard FIG. 4 illustrates that variable rotary speed proposed as arrangement for operation with such of mixtures as explained in the sample calculations. For granulated plastic mixed with crumb rubber proposed, its melt condition usually take place and preferably in the top part of the double-auger pyrolysis reactor, and particularly in the second half-screw section of that in the present system as shown in FIG. 4. The arrangement of speed in the auger is important, by this reason the latter auger half is to be reasonably operated at the lower rotary speeds of 2-2.5 times less than the first one for reactor cross-section flow to be near steady and providing a more effective pyrolysis processing condition of longer residence time.

By analogy, the mass and bulk of mixed feed is also much decreased by its devolatilization (evaporating). Due to this, the third and fourth half-screw sections of the reactor are proposed to be more effectively operated at a reduces rotary speed as particularly and preferably shown in FIG. 4. In result, the total residence time in this inventive double-auger reactor is enhanced by around 45%, being that exemplary and proportionally estimated as below for plastics granules with crumb rubber (with accuracy 0.5 minute):

Typical double-auger reactor for plastic-rubber co-pyrolysis
(Both of top and bottom augers made of whole screw design):
residence time in top auger (e.g., 5 rpm)=15 minutes
residence time in bottom auger (2.5 rpm)=30 minutes
total residence time for processing=45 minutes

Innovated double-auger reactor in the present system
(Both of top and bottom augers of half-screw design):
residence time in first half-screw section of top auger (e.g., 5.0 rpm)=7.5 minutes
residence time in second half-screw section of top auger (2.5 rpm)=15 minutes
residence time in third half-screw section of bottom auger (2.0 rpm)=18.5 minutes
residence time in forth half-screw section of bottom auger (1.5 rpm)=24.5 minutes
total residence time for processing=65.5 minutes

With multi-speed pyrolysis processing of mixed feedstock solid mixture with the catalyst used for processing the same, carbon char filling from crumb rubber or wood chips and might be a small amount from that of plastics. These are all feeding from reactor 1a, 1b to a catalyst regeneration retort 1c, doing that by means of a rotary airlock valve 7 as inlet feeder to pyrolysis retort, as well as by the same one 8 for outlet.

These airlock valves are required for separating under low-oxidizing atmosphere pressure with air and steam supply to the retort against both of air outside and pyrolysis reactor inside. A low-oxidizing condition for the catalyst coke impurity to be slowly burning out to gases at the temperature around 500-550° C. is typical for such of catalyst thermal regeneration. This is done with oxidizing air A2 supplied through an adjusting damper valve 20, as well as operating in a counter-flow direction to the catalyst moving bed in a retort as shown in FIG. 3 for effective thermal processing and regeneration.

With the purpose of zero-waste processing, it is also proposed for carbon char to be combusted along with catalyst thermal regeneration within the retort at the same temperature as an alternative option, the latter typically stabilized and balanced with heat release of carbon char by excessive oxidizing air A3 adjusted as mentioned above and being provided additionally with cooling steam supplied from steam boiler 21 by means of the motor controlled valve 20 mentioned above also. This process is self-regenerative catalytic under refinement of char.

Char refinement process is done by stirring as shown in FIG. 3 where the catalyst retort 2 of a paddle-auger type is proposed. This will be operating at a rotary speed of 5 rpm as particularly and preferably shown in FIG. 3. Local spontaneous combustion of carbon char might take place if the low-oxidizing temperature above is not balanced with cooling procedure as described as procedures above.

Provided with stirring at the most rotary speed as exemplary and preferably proposed as 5 rpm as explained above. Paddle-screw capacity is proposed to be minimally corresponding to that of forth half-screw section of the auger of bottom section. The proposed paddle screw rotation of 1.5 rpm and which is equivalent to time duration of 14.5 minutes. The proposed residence time in the heat box for a whole-screw design will result not less than or twice the half-screw which means particularly not less than 29 minutes. Similar to the above paddle screw arrangement, residence time duration for cooling and unloading/discharge of catalyst conveying screw 10 is also proposed around 30 minutes and corresponding cooled catalyst discharge temperature of 50° C. By this approach, CW-auger screw 10 operated correspondingly as exemplarily at the same low rotary speed of 1.5 rpm as shown in in FIGS. 1-3.

The disclosed embodiments also provide pollutant reduction with purpose to minimize NOx emission which might occur in the gas furnace 3 operated specially at the high temperature regime of 1000° C. So, to prevent dioxin formation from taking place at the lower value of that, combusted flue gas from the retort 2 is proposed for recirculation into the same furnace as shown in FIGS. 1-3. It is done by analogy so called MILD-combustion method with EGR-factor (exhaust gas recirculation) of that as known and recommended namely for NOx reduction in the high-temperature combustion zone as shown in FIG. 5. As well as doing that by itself due to the furnace under-pressure around −50 Pa as mentioned above.

As for pyrolysis oil production using series oil condensers 11 and 12 of vertical and horizontal shell-and-tubes with the purpose of selective condensing of heavy oil fractions in a first condenser is innovated by supplying cooling water at ambient temperature which is usually applied in a conventional pyrolysis process. It is noted herein that boiling water supply is at 100° C. from steam boiler 21 by this preferably condensation of 65% pyrolysis oil as pyrolysis vapour cool down from 400° C. of inlet temperature to 200° C. outlet of the condenser 11 as shown in FIG. 6(a).

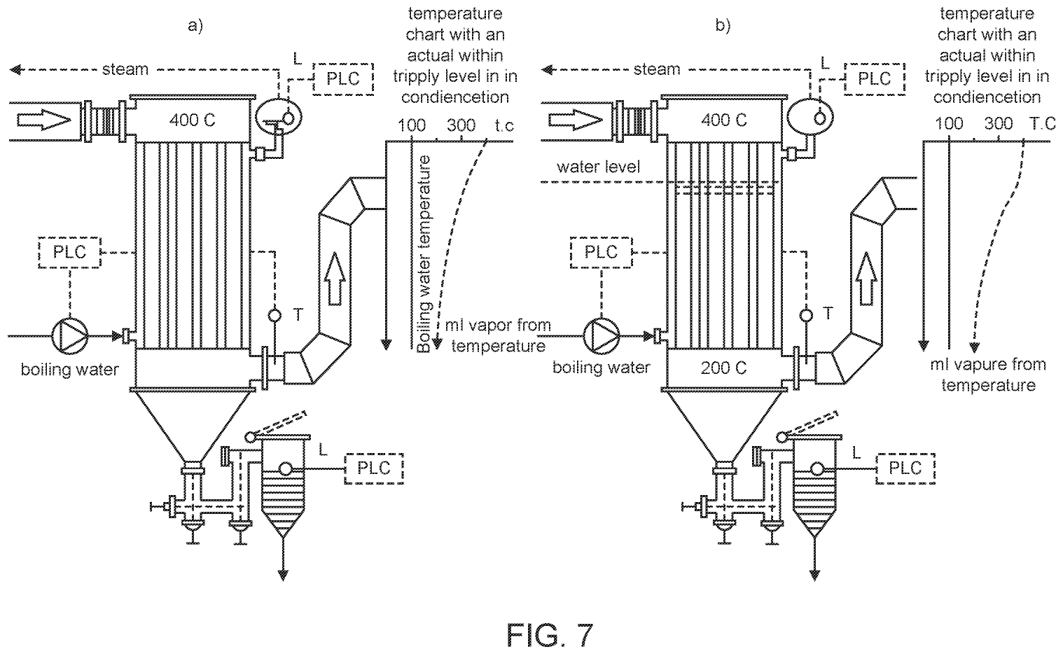

Due to being at or near water boiling temperature, some of the fractions are evaporating and these non-condensable gases are recycled though steam piping back into the boiler drum. This new condenser condensing temperature is controlled by PLC-control or manual procedure of that with water supply rate. The water supply rate usually depended on the oil vapour outlet temperature. The difference is also that even the water flow rate is variable, and the water temperature is steady as 100° C. However, the water level in the condenser is the only variable between the tube bundles as shown in FIG. 7 whereby the tube condensing surface is also considered as variable as required for such of a new control mode sequence.

In contrast to the vertical condenser 11 the water level in the horizontal condenser 12 will be steady as shown in FIG. 6(a). Due to steady temperature available to condense light oil fractions at the proposed temperature around 65-70° C. as compared to oil flash point around 55-60° C. This is unlike known devices and methods as equipped with both top and bottom tube bundles in the condenser bulk water as shown in FIG. 6(b). In this arrangement, oil vapour flow is cooling and condensing in the bottom bundle and in the top tube bundle is supplied with ambient cooling water quenching bulk water in condenser 12 to be at the temperature 65-70° C. as indicated above. The advantage is that there is a natural (gravity) water circulation of close-loop type in such of condenser whereby relatively cold bulk water supply from the top area. It is cooling with ambient water supplied into the top tube bundle and circulating downwards to the bottom area. At the bottom tube bundle areas which is heating with oil condensed and along with its circulating upwards again as shown arrow in FIG. 6(b), doing that in the same temperature range as indicated above.

As for other embodiments and arrangements for these condensers, both are equipped with the oil based hydraulic airlock vessels 13 of open column type for piping the oil from them with possibility of looking at oil flowing down from the condenser as shown in FIG. 6-7. The oil pipes from the heavy oil condenser 11 are made by all rectangular design and all the piping arrangement is equipped with a pack-sealing piston bar. This is to allow possibility of cleaning the pipes against tar or wax plugging in case of its solidification. This avoids urgent stop and cooling down of the system for a long time. As well as the oil vapour pipes arrangement into these condensers are equipped with the thermal extension joints 14 of multi-lens industrial type due to hot pipe as usually. The water pump 16 of screw type is preferably arranged with PLC-control procedure for both boiling and cooling water supply as mentioned above. The flexible to tune as variable and continual water supply mode at the same time.

### LIST OF FIGURE DETAILS

1a First auger reactor
1b Second auger reactor
1c Third tubular reactor/catalyst regeneration
2 heat box/retort/
3 gas flame furnace
4 industrial oil burner for start preheating
5 gas fan for piping that into furnace
6 combustion air blower for prestart
7 airlock valve
8 airlock valve
9 airlock valve
10 discharge auger/CW auger screw
11 vertical oil condenser/heavy oil condenser
12 horizontal condenser for light oil fractions
13 air lock vessel
14 thermal extension joints
15 pyrolysis oil pumps of gear type
16 cooling water screw pump
17 pack sealing piston bar
18 control valve
19 flip flap dumper arrangement (valve)
20 air adjusting damper valve
21 steam boiler
22 Vent valve

1-17. (canceled)

18. A method for pyrolysis-based production of hydrocarbon oils from a first plastic raw material, comprising the steps of:
(a) providing a plastic raw material;
(b) adding a catalyst to the plastic raw material to thereby form a reaction composition;
(c) charging the reaction composition through an airlock valve (7) to an auger pyrolysis reactor comprising at least two auger reactors (1a, 1b) heated to a temperature within an approximate range of 450-550° C.;
(d) diverting oil vapours and non-condensable vapours from the auger reactors (1a, 1b) to a condensing device; and
(e) condensing a heavy oil fraction and a light oil fraction from said vapours.

19. The method of claim 18, wherein the plastic raw material includes at least one second raw material selected from the group consisting of (i) a hydrocarbon containing raw material selected among crumb rubber, and (ii) wood chunks, in an amount greater than 15% by weight of the combined raw material.

20. The method of claim 18, wherein the step of condensing is performed in two sub-steps (11, 12).

21. The method as claimed in claim 18, wherein the plastic raw material is not combined with a second raw material and the catalyst is selected from one or more of Al₂O₃, CaCO₃, MgCO₃, and fly ash.

22. The method according to claim 19, wherein the plastic raw material is combined with a second raw material and the catalyst is one or more zeolitic catalysts.

23. The method according to claim 18, further comprising a step of treating char resulting as a residue from step (c) at a temperature within an approximate range of 500-550° C., thereby generating carbon monoxide and hydrogen.

24. The method according to claim 23, wherein the step of treating char is performed in a tube reactor provided with a paddle-auger for agitation.

25. The method according to claim 23, further comprising a step of regenerating coke forming catalysts during the step of treating char.

26. The method according to claim 18, comprising heating the reactors at least partially by heat produced by a burner charged with the non-condensable gases formed in the auger reactor.

27. The method according to claim 18, wherein the heavy oil fraction is condensed using boiling water at a temperature of about 100° C.

28. The method according to claim 18, wherein the light oil fraction is condensed using warm water at a temperature within an approximate range of 60-75° C.

29. The method according to claim 19, wherein the second raw material comprises only crumb rubber, and is present in an amount no less than 30% by weight.

30. A reactor assembly for pyrolysis-based production of hydrocarbon oils from a first raw material comprising plastic materials, comprising:
a feeding arrangement for plastic material and at least one additional hydrocarbon containing raw material selected among rubber and wood;
at least one primary shaftless double-auger (1a, 1b), a helical reactor with variable velocity motors allowing different rotational speed at an outlet relative to rotational speed at an inlet;
airlock valves (7, 8) at a feeding reactor port and at an exit reactor port;
a third tubular reactor (1c) downstream of the at least one primary double-auger reactor (1a, 1b);
a heat box (2) enclosing at least the double-auger reactor (1a, 1b) and the tubular reactor (1c);
at least one double-stage installation of oil condensers;
a burner (4) configured for heating the reactor assembly and arranged to be charged by non-condensable combustible gas; and
a boiler (21) configured for generating warm water and steam to condense pyrolysis gases.

31. The reactor assembly according to claim 30, wherein the oil condensers (11, 12) take the form of shell-and-tube.

32. The reactor assembly according to claim 30, wherein the third tubular reactor (1c) includes a shafted paddle arranged to regenerate catalyst using thermal oxidation.

33. The reactor assembly according to claim 32, wherein the third tubular reactor (1c) is hermetically separated from the at least primary double auger reactor (1a, 1b).

34. The reactor assembly according to claim 32, comprising an oxidizing air and cooling steam supply port (20) at an inlet to the third tubular reactor (1c).

35. The reactor assembly according to claim 33, comprising an oxidizing air and cooling steam supply port (20) at an inlet to the third tubular reactor (1c).

36. The reactor assembly according to claim 33, further comprising means to transfer exhaust gas from the outlet of the third tubular reactor (1c) to the burner.
